(19) United States
(12) Patent Application Publication
(10) Pub. No.: US 2004/0191068 A1
(43) Pub. Date: Sep. 30, 2004

(54) Moving-blade row for fluid-flow machines

(76) Inventors: Christoph Richter, Ibbenburen (DE); Heinrich Stuer, Haltern (DE); Frank Truckenmuller, Mulheim (DE)

Correspondence Address: SIEMENS CORPORATION, INTELLECTUAL PROPERTY DEPT., 170 WOOD AVENUE SOUTH, ISELIN, NJ, 08830, US

(21) Appl. No.: 10/797,376

(22) Filed: Mar. 10, 2004

(30) Foreign Application Priority Data
Mar. 28, 2003 (EP) 03007139.3

(51) Int. Cl. F03B 3/12

(52) U.S. Cl. 416/223 R

(57) ABSTRACT

The invention relates to a moving-blade row of a fluid-flow machine, the moving-blade row having individual adjacent moving blades which each have a moving-blade root and a moving-blade center region and also a moving-blade tip and a leading edge and a trailing edge, the moving blades being mechanically connected to one another in the moving-blade center region by supporting elements in such a way that undesirable vibrations of the moving blades are effectively avoided.

### CROSS REFERENCE TO RELATED APPLICATION

This application claims priority of the European application No. 03007139.3 EP filed Mar. 28, 2003 under the European Patent Convention and which is incorporated by reference herein in its entirety.

### FIELD OF INVENTION

The invention relates to a moving-blade row of an axial turbine or of a compressor.

### BACKGROUND OF INVENTION

In steam turbine construction, moving-blade rows which have a large incident-flow area are used in particular in the low-pressure region. The respective moving blades of such moving-blade rows are comparatively long in their radial direction. Such moving blades may have a length of over one meter. At the number of revolutions which can be achieved during operation, the centrifugal forces in the moving blades are so great that light material has to be used. Titanium or titanium alloy has proved successful in this respect and is frequently used nowadays in steam turbine construction. Due to the low density of titanium or titanium alloy, the centrifugal forces in moving blades produced from titanium or titanium alloy are low. A disadvantage in this case is the low inherent damping of these moving blades. The moving blades of a moving-blade row which are produced from titanium or titanium alloy lead to undesirable vibrations during operation, and these vibrations have to be damped. A proven measure in this case is to couple the moving blades to one another by the moving-blade tips being virtually wedged together mechanically by “shroud bands”, so that the vibrations of moving blades about an axis which extends radially from the blade root to the blade tip are prevented.

One possibility of reducing moving-blade vibrations is described, for example, in U.S. Pat. No. 5,695,323. In this case, wedge-shaped projections of the blade tips are formed in such a way that in each case two moving-blade tips are hooked together in such a way that vibrations of the moving blades are prevented. The wedge-shaped projections of these moving-blade tips are comparatively large and also lead here to large centrifugal forces and thus to increased material stress.

A further method of preventing vibrations is described in DE 101 08 005 A1. In this case, two supporting vanes are arranged in the center region of a moving blade. The supporting vanes are parallelogram-like in cross section. In each case two supporting vanes are brought into contact with one another in such a way that a rotation in one direction of a moving blade is countered. A second row of supporting vanes is likewise of parallelogram-like construction and the supporting vanes are in contact with one another in such a way that a rotation in the opposite direction of rotation is reduced. In addition to these supporting-vane arrangements, further supporting elements which form a “shroud band” and prevent vibration of the moving blades are attached to the respective moving-blade tips. A disadvantage in this case is the comparatively large supporting vanes, which lead to large centrifugal forces. Furthermore, these supporting vanes are aerodynamically formed in such a way that they form an increased flow resistance.

Presented in DE 11 59 965 are moving blades which have shroud plates at the moving-blade tips, these shroud plates being of parallelogram-like design and being in contact with one another in such a way that vibration damping is achieved.

Such an arrangement can also be gathered from DE 33 06 143 A1.

DE 100 14 189 A1 likewise offers a solution for reducing vibrations, supporting elements which have a relatively large spatial extent again being used here.

Presented in GB 2 105 414 are supporting elements which are used in the moving-blade tip region. In this case, tube-like supporting elements are arranged between two moving blades in such a way that the moving-blade trailing edge of one moving blade is mechanically connected to the moving-blade leading edge of a next moving blade. As a result, the vibration of one moving blade has an effect on the vibration of a next moving blade.

The restraint, shown in GB 2 105 414 B, of the moving-blade rows in the head region has the disadvantage of an aerodynamic effect, which is not desirable.

In some of the possibilities, belonging to the prior art, for damping vibrations of moving blades it is disadvantageous that, due to the use of supporting vanes or similar components, the moving blades have to be restrained together in such a way that the vibration is certainly reduced on the one hand, but additional mechanical loading is effected by the restraint on the other hand. This mechanical loading could lead to cracks in the moving blades. Furthermore, the supporting vanes or similar components presented in the prior art, from the point of view of their spatial extent, are so large that enormous centrifugal forces are produced during operation and fracture of the supporting vanes is possible.

### SUMMARY OF INVENTION

The object of the present invention is to prevent the vibrations of a moving blade in a moving-blade row of a fluid-flow machine.

The object is achieved by a moving-blade row of a fluid-flow machine, the moving-blade row having individual moving blades which each have a moving-blade root, a moving-blade center region, a moving-blade tip and a leading edge and a trailing edge, the moving blades having shroud plates at the moving-blade tips, and a supporting element being attached between at least two adjacent moving blades in the moving-blade center region in such a way that the supporting element couples the two adjacent moving blades to one another. The coupling of the adjacent moving blades via the supporting element refers to any possible type of fastening. In other words: a supporting element is arranged between two adjacent moving blades in the moving-blade center region in such a way that the two moving blades are fastened to one another.

The advantage of this supporting element lies in the low mass and the small spatial extent. The low mass of this supporting element leads to low centrifugal forces during operation. In addition, the production or fitting of this supporting element is comparatively simple. An aerodynamically advantageous behavior during operation is achieved by the small spatial extent.

In an advantageous configuration, the leading edge of a moving blade is coupled to the trailing edge of an adjacent moving blade via the supporting element. During vibration of the moving blades, the amplitudes at the leading and trailing edges, respectively, are the greatest. Coupling the leading edge to the trailing edge leads to an especially effective reduction in the vibration amplitude.

In an advantageous configuration, the supporting element is designed as a pin. The advantage in this case lies in the simple production of this arrangement.

In a further advantageous configuration, the supporting elements are used for moving blades which have been produced from titanium or titanium alloy.

In a development, the moving-blade row is used in a fluid-flow machine, such as, for example, a steam turbine, gas turbine or compressor.

### BRIEF DESCRIPTION OF THE DRAWINGS

An exemplary embodiment of the invention is explained in more detail with reference to a drawing, in which, in detail:

FIG. 1 shows the partial cross section of a double-flow low-pressure steam turbine;

FIG. 2 shows two moving blades, connected via a supporting element, of a moving-blade row;

FIG. 3 shows a plan view of a shroud band of the moving blades;

FIG. 4 shows a plan view of two moving blades with a supporting element.

### DETAILED DESCRIPTION OF INVENTION

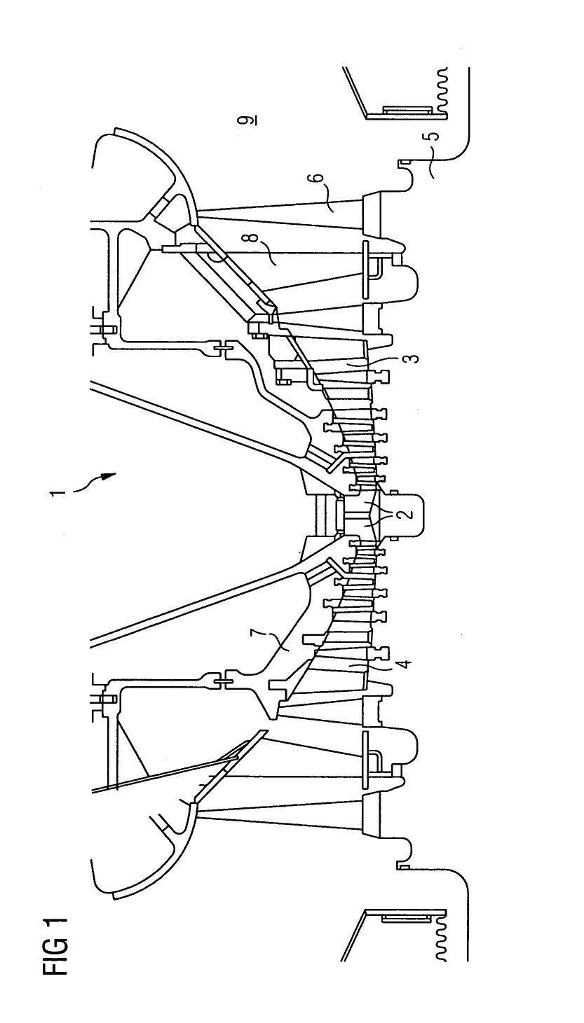

A partial cross section of a low-pressure steam turbine 1 is shown in FIG. 1. Via an inflow region 2, a flow medium flows through the flow passages 3, 4. A rotatably mounted rotor 5 has various moving-blade rows which are at a distance from one another in the axial direction and of which, for the sake of clarity, only one moving-blade row 6 is provided with a designation 6. Guide blades 8 are attached to an inner casing 7. The expanded steam passes out of the low-pressure steam turbine 1 via an outflow connection piece 9. In the process, the rotor 5 is moved in a rotary movement about a rotation axis 10.

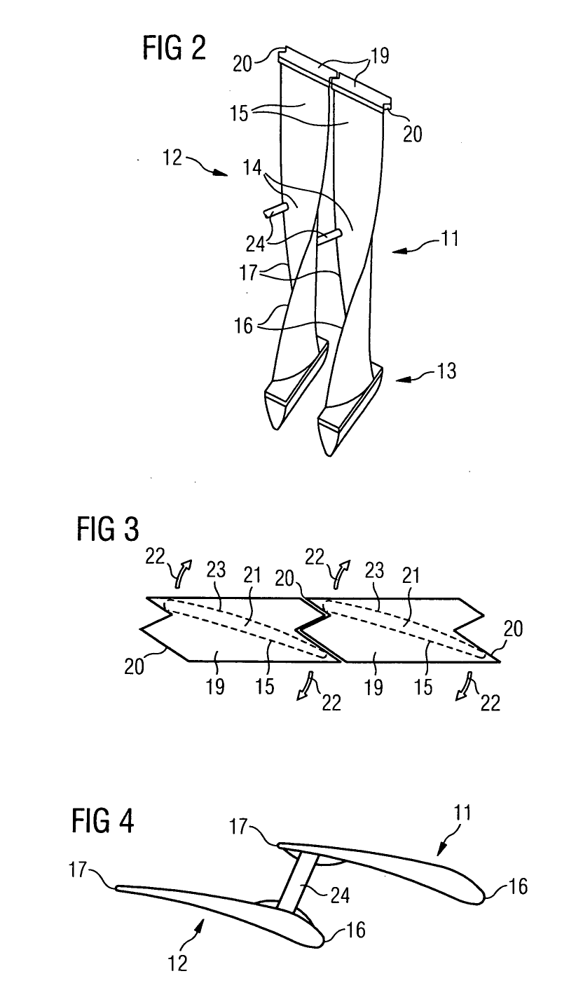

Two moving blades 11, 12 of a moving-blade row 6 are shown in FIG. 2. The moving blades 11, 12 have a moving-blade root 13, a moving-blade center region 14 and a moving-blade tip 15. Furthermore, the moving blades 11, 12 have a leading edge 16 and a trailing edge 17. Shroud plates 19 perpendicular to the radial orientation 18 of the moving blades 11, 12 are attached to the moving-blade tips 15. The radial orientation 18 is shown by the arrow 18. The shroud plates 19 are arranged in such a way that they project beyond the moving-blade tips 15 perpendicularly to the radial orientation. Furthermore, the shroud plates 19 are formed from the leading edge 16 up to the trailing edge 17.

The shroud plates 19, as viewed in the radial direction 18, have a saw-tooth-shaped contact region 20 at the leading edge 16 and at the trailing edge 17. In this case, the saw-tooth-shaped contact region 20 is designed in such a way that two shroud plates 19 are attached one inside the other and make contact. This means that the moving blades 11, 12 are restricted in their vibratory movement about a center of rotation 21. A rotation is indicated by the arrows 22 in FIG. 3, but this rotation is prevented by the saw-tooth-shaped geometry 20 of the two shroud plates 19 in contact.

FIG. 3 shows a view of the shroud plates 19 along the radial orientation 18. The two broken lines 23 indicate a moving-blade tip 15.

Two moving blades 11, 12 are shown in FIG. 4. Here, as in FIG. 3, the direction of view is along the radial orientation 18. For the sake of clarity, the illustrations of the shroud plates 19 have been omitted. A section through the moving blades 11, 12 in the moving-blade center region 14 can be seen. A supporting element 24 is attached to the trailing edge 17 of the moving blade 11. The supporting element 24 is connected to the leading edge 16 of the moving blade 12. The supporting element 24 can be fastened to the trailing and leading edges 16, 17 by welding or screwing. Further possibilities for fastening the supporting element 24 to the leading and trailing edges 16, 17, respectively, are described in document GB 2 105 414.

The moving-blade roots 13 are attached to the rotor 5 (not shown in any more detail in FIG. 4).

In the embodiment according to FIG. 4, the supporting element 24 is designed as a pin.

1. A blade row of a turbo-machine, comprising:
a blade having a root, a center region, a tip, a leading edge and a trailing edge, the blades arranged circumferentially adjacent to each other to form a row;
a shroud plate arranged at each blade tip, the shroud plate adapted to inhibit untwisting of the blades; and
a support element arranged between adjacent blades located approximately in the blade center region and coupling the adjacent blades.

2. The blade row 95 claimed in claim 1, wherein the leading edge of the blade is coupled to the trailing edge of an adjacent blade by the supporting element.

3. The blade row as claimed in claim 1, wherein the supporting element is a pin.

4. The blade row as claimed in claim 1, wherein the blades are formed from titanium or a titanium alloy.

5. The blade row as claimed in claim 1, wherein the turbo-machine is a fluid flow machine.

6. A rotating blade for use in a turbo-machine, comprising:
a first rotating blade with a first leading edge, a first trailing edge, a first blade tip, a first blade root, a first blade center region, and a first blade shroud located near the first blade tip;
a second rotating blade with a second leading edge, a second trailing edge, a second blade tip, a second blade root, a second blade center region, and a second blade shroud located near the second blade tip; and
a support element located between the first rotating blade and the second rotating blade and arranged approximately in the blade center region, and adapted to couple the first rotating blade to the second rotating blade.

7. The rotating blade as claimed in claim 6, wherein the first rotating blade is located adjacent to the second rotating blade.

8. The rotating blade as claimed in claim 6, wherein a plurality of first rotating blades and second rotating blades are arranged on a rotor of the turbo-machine to form a row of rotating turbine blades.

9. The rotating blade as claimed in claim 6, wherein the first rotating blade shroud has a contact face and the second rotating blade shroud has a contact face.

10. The rotating blade as claimed in claim 9, wherein the first rotating blade shroud contact face is arranged approximately opposite to the second rotating blade shroud contact face.

11. The rotating blade as claimed in claim 10, wherein blade untwist is prevented by the first rotating blade shroud contact face contacting the second rotating blade contact face during operation.

12. The rotating blade as claimed in claim 6, wherein the leading edge of the first rotating blade is coupled to the trailing edge of the second rotating blade by the supporting element.

13. The rotating blade as claimed in claim 6, wherein the supporting element a pin.

14. The rotating blade as claimed in claim 6, wherein the rotating blade is formed from titanium or a titanium alloy.

15. A method for reducing vibration in a rotating blade within a turbo-machine, comprising:
assembling a first rotating blade on a turbine rotor;
assembling a second rotating blade on the turbine rotor so the first rotating blade and second rotating blade are adjacent;
installing a support element between the first rotating blade and the second rotating blade, the support element located approximately in the blade center region; and
coupling the first rotating blade to the second rotating blade.

16. The method as claimed in claim 15, wherein the support element is a pin.

17. The method as claimed in claim 15, wherein the rotating blade is formed from titanium or a titanium alloy.

18. The blade row as claimed in claim 1, wherein untwisting inhibition is provided by contact between the shroud plates of adjacent blades during operation.
